(19) United States
(12) Patent Application Publication
(10) Pub. No.: US 2024/0251996 A1
(43) Pub. Date: Aug. 1, 2024

(54) METHOD FOR GRINDING MATERIAL TO BE GROUND

(71) Applicant: Jura Elektroapparate AG, Niederbuchsiten (CH)

(72) Inventor: Christoph GROB, Zofingen (CH)

(73) Assignee: Jura Elektroapparate AG, Niederbuchsiten (CH)

(21) Appl. No.: 18/565,155

(22) PCT Filed: May 24, 2022
(86) PCT No.: PCT/EP2022/064020

§ 371 Date: Nov. 29, 2023

(30) Foreign Application Priority Data
Jun. 1, 2021 (EP) 21177222.3

(51) Int. Cl. A47J 42/08; A47J 31/42; A47J 42/32

(52) U.S. Cl. CPC A47J 42/08; A47J 31/42; A47J 42/32

(57) ABSTRACT

The invention relates to a method for grinding material to be ground having at least one grinding mill in a coffee machine, the method comprising: determining an actual grind level of the grinding mill; determining a target grind level of the grinding mill; automatically comparing the actual grind with the target grind level; and automatically outputting information to a user of the grinding mill based on the comparison of the actual grind level with the target grind level.

### FIELD OF THE INVENTION

The invention relates to a method for grinding material to be ground, using at least one grinding mill in a coffee machine.

Grinding mills in coffee machines are known which comprise an adjustment device for setting the grind level of the grinding mill. As a rule, the adjustment of the grind level, for example to achieve a certain coffee powder fineness, can be set manually or automatically. In some grinding mills, the grinding mill can be set or adjusted by the user of the grinding mill themselves.

Furthermore, devices are known, for example coffee machines or fully automatic coffee machines, which comprise both one or more grinding mills and means for processing ground coffee. For example, the device can use ground material ground by the one or more grinding mills to prepare a product, for example a specific coffee product. A different grind level may be optimal or recommended for different products to be prepared. For example, the use of a different coffee powder fineness is optimal or recommended for the preparation of different coffee products.

In order to provide a user of such a device with a variety of individual setting options, the user can often select or set a product to be prepared on the one hand and a desired grind level on the other separately.

The problem here is that a set grind level may not correspond to an optimum or recommended grind level for a specific product to be prepared, which can reduce the quality of the product and thus impair the user-friendliness of the device.

The present invention is therefore based on the object of improving the user-friendliness of a method for grinding material by providing individual setting options for the grinding process.

### BACKGROUND OF THE INVENTION

The solution for this object in the method mentioned at the beginning for grinding material to be ground having at least one grinding mill in a coffee machine consists in particular in the fact that the method comprises: determining an actual grind level of the grinding mill, determining a target grind level of the grinding mill based on a coffee product selected by a user, automatically comparing the actual grind level with the target grind level, and automatically outputting information to a user of the grinding mill based on the comparison of the actual grind level with the target grind level.

This allows the user of the grinding mill to be informed of the set actual grind level of the grinding mill. This improves the user-friendliness of the grinding mill while at the same time providing individual adjustment options for the grinding mill, especially if the actual grind level does not match the target grind level.

### SUMMARY OF THE INVENTION

The actual grind level can be determined, for example, via the position of the grinding mill. In particular, the actual grind level can be determined via the relative distance between two grinding or cutting tools. In addition or alternatively, the actual grind level can be determined via the position or setting of an adjustment device for setting a grind level.

The target grind level is determined based on a coffee product selected by a user. In addition or alternatively, the target grind level can be predetermined or determinable. The target grind level can, for example, be stored in a (device) controller of the grinding mill or a device comprising the grinding mill or can be queried by the latter. The target grind level can be assigned to one or more specific products that are to be prepared with ground material of the target grind level. The target grind level can be determined or is determinable based on a user selection of a product to be prepared with the ground product.

The automatic comparison of the actual grind level with the target grind level can be carried out in particular before the grinding of the material to be ground. The comparison can be carried out by a (device) controller of the grinding mill or a device comprising the grinding mill or an external (device) controller.

The automatically issued notification to the user of the grinding mill can be a visual, haptic and/or acoustic notification, for example.

In one embodiment, it is provided that the method further comprises: receiving a first user input, and determining the target grind level based on the received first user input.

For example, the first user input is aimed at selecting a product to be prepared based on or using the ground material. For example, the grinding mill is a coffee grinding mill in a coffee machine. In this example, the target grind level can be determined based on the selection of a coffee product. In this way, the user of the grinding mill can be advised of a recommended or optimum grind level for the selected product. This serves to support the user in the preparation of high-quality products and further improves the user-friendliness of the process.

In one embodiment, it is provided that the method further comprises: outputting information to the user of the grinding mill if the actual grind level does not match the target grind level, in particular wherein it is automatically output whether and/or by how much the actual grind level should be increased or decreased in order to achieve the target grind level.

In particular, the actual grind level does not match the target grind level if the actual grind level or an actual grind level range assigned to the actual grind level does not or does not at least partially match a target grind level range assigned to the target grind level. The actual grind level range and/or the target grind level range can be predetermined or determinable. In particular, a magnitude or width of the actual grind level range and/or the target grind level range can be determined based on a user input, for example based on a product to be prepared selected by the user. In this way, the information can be directed towards increasing or decreasing the actual grind level in order to directly or indirectly prompt the user to achieve a change in the actual grind level to the target grind level. This further improves the user-friendliness of the grinding process.

In one embodiment, it is provided that the method further comprises: grinding the material to be ground with the actual grind level when the actual grind level matches the target grind level, and/or grinding the material to be ground with the actual grind level when the actual grind level does not match the target grind level, and/or adjusting the actual grind level to set the target grind level when the actual grind level does not match the target grind level.

For example, the method can include grinding the material to be ground with the actual grind level only if the actual grind level matches the target grind level. In this way, the preparation of a product with ground material with a non-optimal grind level is prevented. Furthermore, the method can include grinding the material to be ground with the actual grind level, even if the actual grind level does not match the target grind level. This allows the user to make individual adjustments to the grinding mill, which may not correspond to the recommended or objectively optimal settings, depending on the user's perception. Furthermore, the method can include adjusting the actual grind level to set the target grind level if the actual grind level does not match the target grind level. In this way, the user-friendliness of the method is further increased by the fact that an optimum target grind level is set, for example with reference to the non-optimum actual grind level, before a product associated with the target grind level is prepared.

In one embodiment, it is provided that the method further comprises: receiving a second user input, wherein grinding the material to be ground with the actual grind level and/or adjusting the actual grind level is performed in response to receiving the second user input. For example, the second user input is received following and/or in response to the information being issued to the user. In particular, the second user input is a response to the information, or a confirmation of the information, by the user. The second user input can be directed to a confirmation that the grinding of the material to be ground should be carried out with the actual grind level, in particular despite the fact that the actual grind level does not match the target grind level. Alternatively, the second user input can be directed to a confirmation that the grinding of the material to be ground should be carried out with the target grind level, in particular instead of grinding the material to be ground with the actual grind level. In addition or alternatively, the second user input can be directed to a confirmation that the grind level is to be (automatically) adjusted from the actual grind level to the target grind level or that the user wishes to adjust it.

In one embodiment, it is provided that the grinding of the material to be ground with the actual and/or the desired grind level takes place in response to the expiry of one or more preferably predetermined first time intervals, in particular from the first user input, the second user input, the adjustment of the grind level, the adjustment of a control element and/or the output of the information to the user.

For example, the user can be given time from a user input or from the notification to the user to make a decision regarding the grind level, in particular whether an adjustment, and in particular which adjustment, of the grind level should take place. Furthermore, the method can carry out the grinding process with the actual grind level or the target grind level if a predetermined time interval has expired or elapsed. In other words, an elapsed time interval without user input is interpreted as user consent. This further increases the user-friendliness of the method.

In one embodiment, it is provided that the adjustment of the actual grind level takes place in response to the expiry of one or more preferably predetermined second time intervals, in particular from the first user input, the second user input, the adjustment of the or a control element and/or the output of the information to the user. In this way, the grind level can be adjusted automatically without depriving the user of the possibility of grinding material to be ground with the (non-optimal, non-recommended or non-preset) actual grind level.

In one embodiment, it is provided that the information to the user of the grinding mill comprises an indication of the actual and/or the desired grind level, and/or wherein the information to the user of the grinding mill comprises an indication of a desired setting of a control element of the grinding mill for setting the grind level.

In this way, the user can be informed about a set (actual) and/or a recommended (target) grind level, in particular about an option for setting the recommended grind level. This represents an improvement in supporting the user in selecting the grind level, in particular for a specific product to be prepared.

In one embodiment, it is provided that the information to the user of the grinding mill comprises a specification for setting the target grind level and/or a specification for adjusting the control element of the grinding mill. For example, the user is visually shown the (on) position of a control element that leads to the setting of the target grind level. The user can also be shown an adjustment direction of the control element that can be used to set the target grind level. The information or display can, for example, be visual, haptic and/or visual.

In one embodiment, it is provided that the determination of the actual grind level comprises the determination of an actual value or an actual value range for the set grind level, wherein the determination of the target grind level comprises the determination of a target value or a target value range for the target grind level, and wherein the output of the information to the user of the grinding mill comprises the output of information to the user of the grinding mill when the target value or target value range does not at least partially correspond to the actual value or actual value range. The actual value, the actual value range, the target value and/or the target value range can be predetermined or determinable. The actual value range and/or the target value range, in particular their width, can be dependent on the actual value and/or the target value, in particular their height. In this way, tolerance ranges can be determined in which the actual grind level is considered to be greater than the target grind level.

In one embodiment, it is provided that the determination of the actual grind level comprises the determination of a position of a control element of the grinding mill and/or the determination of a position of an adjustable grinding mill element of the grinding mill, in particular the determination of a position of a first grinding mill element of the grinding mill relative to a second grinding mill element of the grinding mill.

For example, the control element is a rotary switch that can be operated by the user. In this example, the actual grind level can be determined by detecting the rotary position of the rotary switch. The first and second grinding mill elements can be a first and a second grinding tool. The first grinding mill element can be a grinding cone, for example, and the second grinding mill element can be a grinding ring, for example, or vice versa. The first and second grinding mill elements can have cutting edges, in particular form a grinding gap delimited by the respective cutting edges. The grinding gap can be larger or smaller depending on the relative distance between the grinding elements. The size or width of the grinding gap can be used to set a specific grind level or to grind material to a specific grind level.

In one embodiment, it is provided that the grinding mill comprises sensors and that the determination of the actual grind level, in particular the determination of the position of a control element of the grinding mill, in particular a control element of a preferably manually operable and/or mechanical adjustment device of the grind level, and/or the determination of the position of the grinding mill element of the grinding mill, is carried out on the basis of sensor data of the sensors. The sensors can, for example, comprise one or more (mechanical) sensors, in particular micro-sensors. The grinding mill, one or more grinding mill elements, the control element and/or the adjustment device can have elevations or other sensing means that actuate the sensor differently, or different sensors, depending on the setting position. Additionally or alternatively, the sensors may comprise (electro-) magnetic sensors.

In one embodiment, it is provided that the information is output to the user of the grinding mill visually, preferably via a display and/or via the illumination of at least one region of the control element. For example, an area or individual areas of the control element can be illuminated to indicate a setting of the control element or an adjustment direction of the control element.

In one embodiment, it is provided that the method comprises the grinding of material to be ground with a plurality of grinding mills, wherein the output of the information to the user of the grinding mill based on the comparison of the respective actual grind level with the respective target grind level comprises the output of respective, in particular different, information. For example, the information relating to the respective grind levels of the grinding mills may be identical, in particular indicating an identical actual grind level and/or an identical target grind level. Additionally or alternatively, the information relating to the respective grind levels of the grinding mills may be different, in particular indicating different actual grind levels and/or different target grind levels. In this way, the target grind level of a specific grinding mill can be determined based on a material to be ground with the specific grinding mill. For example, the material to be ground with a particular grinding mill can be predetermined. In addition or alternatively, the material to be ground with a specific grinding mill can be determined, for example using sensors that detect the properties of the material to be ground (such as the size and/or coloration) and thus identify the material to be ground.

In one embodiment, it is provided that the grinding mill is a coffee grinding mill and the first user input is associated with the selection of a coffee product.

In one embodiment, the method further comprises: actuating a cleaning operation to clean the grinding mill, in particular when the actual grind level does not match the target grind level and preferably in response to or during the output of the information. For example, actuating the cleaning operation comprises adjusting the actual grind level to set a transitional grind level different from the target grind level, which is preferably coarser than the actual grind level and/or the target grind level. In particular, the transitional grind level can be set if the target grind level is finer than the actual grind level. The transitional grind level can be coarser than the actual grind level and the target grind level.

Likewise, the actuation of the cleaning process can include the actuation of the grinding mill in a reverse direction, preferably opposite to a grinding direction. For example, the grinding mill is actuated in a first (rotational) direction to grind material. In this example, the reverse direction is a second (rotational) direction opposite to the first. The actuation of the grinding mill in the first and/or the second direction can be an actuation of a first grinding element of the grinding mill relative to a second grinding element of the grinding mill. The first and second grinding elements may be, for example, cutting tools or other grinding tools for grinding material to be ground. In other words, the method comprises a cleaning rotation of the grinding mill, which can be triggered in particular simultaneously with the automatic output of the information.

In this way, the grinding mill can be freed from material to be ground or ground material between the grinding tools, in particular before setting a finer grind level. In particular, the material to be ground or ground material can be removed between cutting edges or conveyed out of a grinding gap. In other words, the grinding mill is relaxed before a finer grind level is set. This makes it possible to set a finer grind level, or makes it easier to set the finer grind level, or prevents damage to the grinding mill elements when setting the finer grind level. In addition, this enables the user of the grinding mill to adjust the grinding mill, in particular to set a finer grind level, outside of a grinding process.

In a further possibly independent embodiment, a coffee machine with a grinding mill and a processor is provided, wherein the processor is configured to carry out the method according to one of the preceding claims, in particular wherein the coffee machine has a preferably manually operable and/or mechanical adjustment device of the grind level and/or an optically readable display device, preferably a display and/or a controlled illuminable region.

The invention is described in more detail below with reference to several preferred exemplary embodiments, wherein:

### BRIEF DESCRIPTION OF THE DRAWINGS

FIG. 1 shows a flow diagram of a first method for grinding material to be ground with at least one grinding mill,

FIG. 2 shows a flow diagram of a second method for grinding material to be ground with at least one grinding mill,

FIG. 3 shows a first user interface of a grinding mill,

FIG. 4 shows a second user interface of a grinding mill,

FIG. 5 shows a 3-dimensional view of a device for adjusting and monitoring the grind level of a grinding mill,

FIG. 6 shows a side view of the device for adjusting and monitoring the grind level of a grinding mill,

FIG. 7 shows a top view of the device for adjusting and monitoring the grind level of a grinding mill,

FIG. 8 shows an enlarged section of the side view of the device for adjusting and monitoring the grind level of a grinding mill,

FIG. 9 shows a top view of a transmission element and a sensor of the device for adjusting and monitoring the grind level of a grinding mill.

### DETAILED DESCRIPTION

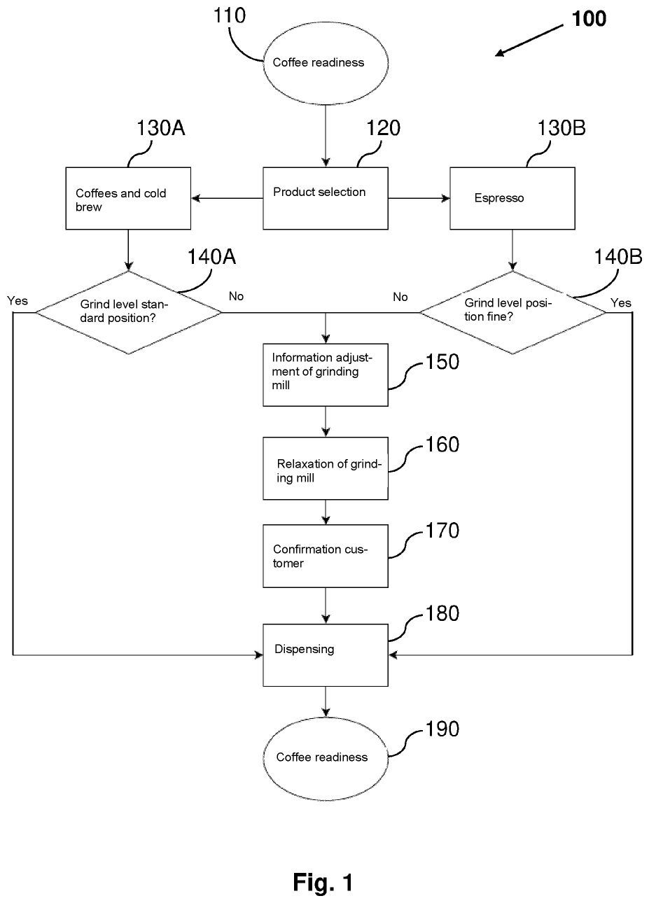

FIG. 1 shows a flow diagram of a first method 100 for grinding coffee beans with at least one grinding mill. The method 100 is a method for grinding coffee beans with at least one coffee grinding mill. The or one of the grinding mills is in a standby or idle state in a first method step 110. In a second method step 120, the method 100 comprises receiving a first user input. The first user input is directed to the selection of a particular coffee product. For example, the first user input is directed to a coffee product from a selection comprising a (standard) coffee, a cold-brew beverage and an espresso. Based on the received first user input, a coffee product selected by the user is determined. For example, in method step 130A, the selected coffee product is determined to be a coffee or a cold-brew beverage. Alternatively, in method step 130B, the selected coffee product is determined to be an espresso. Based on the selected coffee product, a target grind level of the grinding mill is further determined in step 130A or in step 130B. The target grind level of the grinding mill is a grind level of the material to be ground, in this case the coffee beans to be ground, which is optimal, predetermined and/or recommended for preparing the selected coffee product. For example, a different, in particular coarser, coffee powder fineness is required to prepare a coffee or a cold-brew beverage than to prepare an espresso.

In step 140A or in step 140B, following step 130A or 130B, an actual grind level of the grinding mill is determined. The actual grind level of the grinding mill is a set grind level, i.e. the grind level to which the grinding mill is currently set or to which it is set at the time of determination. The actual grind level is determined, for example, via the position of a control element of the grinding mill, in particular a control element for setting the grind level. The actual grind level can also be determined via the position of a specific grinding mill element of the grinding mill, in particular relative to other grinding mill elements of the grinding mill. To determine the actual grind, sensors can be used that are attached to or interact with the control element and/or the specific grinding mill element, for example.

Furthermore, in method step 140A or method step 140B, the actual grind level is automatically compared with the target grind level. By comparing the actual grind level with the target grind level, it can be determined whether the actual grind level matches the target grind level. For example, the actual grind level matches the target grind level if the actual grind level is covered by a target grind level range, in particular one that is assigned to the target grind level. For example, not only one specific grind level, but a plurality of specific grind levels and/or a specific grind level range is optimal, recommended and/or predetermined for the preparation of a specific coffee product.

If the actual grind level corresponds to the target grind level, method step 140A or method step 140B is followed by method step 180, which comprises drawing the material to be ground. Obtaining the material to be ground in method step 180 comprises grinding the material to be ground with the set grind level or with the actual grind level. Obtaining the ground material in step 180 may further comprise preparing the coffee product selected in step 120 with the ground material.

If the comparison of the actual grind level with the target grind level in method step 140A or method step 140B determines that the actual grind level does not correspond to the target grind level, for example is not within a target grind level range, or is not covered by it, information is automatically output to the user of the grinding mill in method step 150. The information can be directed to the actual grind level, the target grind level and/or the lack of correspondence between the actual grind level and the target grind level or target grind level range. The information can also be directed at a request to the user of the grinding mill to change the actual grind level, in particular to change it towards the target grind level, for example to increase or decrease it. In particular, the information can be directed at how much the actual grind level should be increased or decreased in order to achieve the target grind level.

In method step 160, the grinding mill is relaxed. The relaxation of the grinding mill may comprise adjusting the actual grind level to a transitional grind level, wherein the transitional grind level is coarser than the actual grind level. The relaxation of the grinding mill can additionally or alternatively comprise a reverse operation of the grinding mill. The relaxation of the grinding mill can be particularly advantageous if the specified target grind level or the specified target grind level range is finer than the specified actual grind level. This is particularly due to the fact that an adjustment from a first grind level to a second grind level, wherein the second grind level is finer than the first grind level, can be made more difficult or hindered and or can lead to damage to the grinding mill or individual grinding mill elements if there is material to be ground and/or ground material in the grinding mill, in particular between the grinding mill elements, for example in a grinding gap.

Method step 160 can, for example, be carried out (directly) following or simultaneously with method step 150. By relaxing the grinding mill, the user of the grinding mill can, if desired, adjust the grinding mill at any time after noticing the information without having to apply excessive force or without damaging the grinding mill.

In method step 170, a second user input is received from the user of the grinding mill. The second user input can be directed towards an adjustment of the actual grind level, in particular towards the target grind level. For example, the second user input can be directed towards wanting to change and/or having changed the set actual grind level. Furthermore, the second user input can be a grinding mill adjustment made by the user. The second user input can also be a confirmation that the grinding mill is to be automatically adjusted or has been adjusted. Furthermore, the second user input can be directed towards confirming or agreeing with a grinding mill adjustment from the actual grind level to the target grind level that has already been carried out automatically, for example after method step 140 A, 140 B, 150 or 160. Alternatively, the second user input can be directed towards wanting to grind the material to be ground with the actual grind level or the target grind level range despite a mismatch between the actual grind level and the target grind level, or to want to prepare the selected product based on ground material with the actual grind level.

The second user input can also be received without active intervention by the user, for example by determining the expiry of a first time interval. In this way, the user can, for example, confirm an automatic grinding mill adjustment that has taken place or is to take place by allowing the first time interval to elapse or by inactivity in the first time interval. In addition or alternatively, the second user input, for example by an active user input or by not actively allowing the first time interval to elapse, can be directed towards a confirmation by the user to grind the material to be ground with the set or changed actual grind level despite the fact that it does not correspond to the target grind level or the target grind level range. Furthermore, the second user input, for example by an active user input or by not actively allowing the first time interval to elapse, can be directed towards a confirmation by the user to grind the material to be ground with the target grind level.

In other words, the method may provide for a time interval or delay to elapse before the material to be ground is obtained or the material to be ground is ground with the actual grind level or the desired grind level in method step 180. The first time interval to be elapsed can, for example, begin with the receipt of the first or second user input, with the automatic adjustment of the grind level or the adjustment of the grind level by the user, for example by adjusting the control element, with the determination of the actual and/or the target grind level or with the output of the information to the user. This ensures that the user is given sufficient time to adjust the grind level of the grinding mill before starting a grinding process or obtaining the material to be ground.

The method can also provide for a second time interval or delay to elapse before the actual grind level is automatically adjusted. The second time interval can, for example, begin with the receipt of the first or second user input, with the automatic adjustment of the grind level or the adjustment of the grind level by the user, for example by adjusting the control element, with the determination of the actual and/or target grind level or with the output of the information to the user. In this way, the user is given sufficient time to confirm the execution of the grinding process with the target grind level, to set a different desired grind level or to confirm the execution of the grinding process with an actual grind level that deviates from the target grind level.

The method step 180 described above follows the method step 170. For example, the method step 180 begins after the first and/or the second time interval has elapsed.

Similarly, if method step 180 follows method step 140A or method step 140B as described above, it may begin after the first time interval, the second time interval or a third time interval has elapsed. For example, the third time interval begins upon receipt of the first user input or upon determination of the actual and/or target grind level. In this way, if the actual grind level matches the target grind level or the target grind level range within the third time interval, the user has the option of adjusting the grind level despite the match, for example in order to use an individually preferred grind level.

In method step 190, the grinding mill is set to a standby or idle state. The standby or idle state may correspond to the standby or idle state of method step 110.

The method 100 can be applied to several grinding mills. For example, the method steps 110 to 190 are performed separately for each of the grinding mills or together for each of the grinding mills, in particular simultaneously, when grinding material with multiple grinding mills. For example, the plurality of grinding mills may include different material to be ground, which may lead to the determination of a particular target grind level for a particular grinding mill of the plurality of grinding mills, in particular to the determination of different target grind levels for different grinding mills. Similarly, different actual grind levels may be set for different grinding mills, whereby a comparison in method step 140A or in method step 140B may be different for different grind levels.

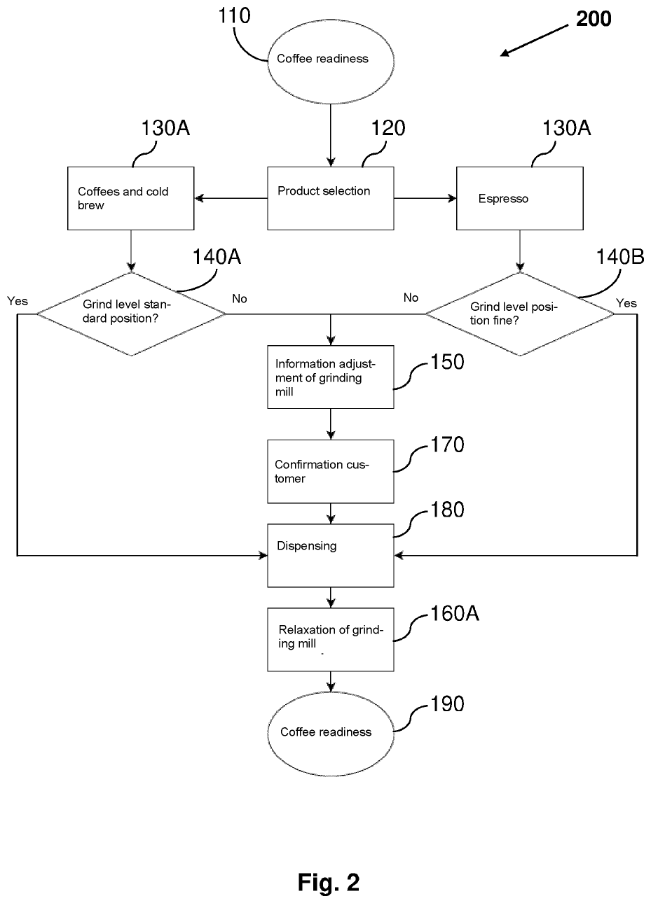

FIG. 2 shows a flow diagram of a second method 200 for grinding material with at least one grinding mill similar to the method 100 of FIG. 1. Identical or similar features or method steps are provided with identical reference signs.

The method 200 does not comprise the method step 160 of method 100. In method 200, a method step 160A follows the method step 180 described with reference to FIG. 1. In method step 160A, the grinding mill is relaxed after the material to be ground has been obtained or the grinding material has been ground in method step 180. The relaxation of the grinding mill can take place or be carried out as in method step 160 of the method 100 of FIG. 1. In particular, method step 160A can be carried out after each method step 180, i.e. after each grinding operation. Alternatively, method step 160A can be performed after a number of method steps 180, i.e. after a number of grinding operations, in particular after a determinable or predetermined number of several grinding operations. This has the advantage that a user of the grinding mill can adjust the grinding mill at any time, in particular can adjust it to finer degrees of grinding at any time. For example, the user of the grinding mill can adjust the grinding mill before, during or after the product selection in step 120 or the receipt of the information in step 150, for example via a control element.

Following method step 160A, the grinding mill is set to a standby or idle state in method step 190, as in method 100 of FIG. 1.

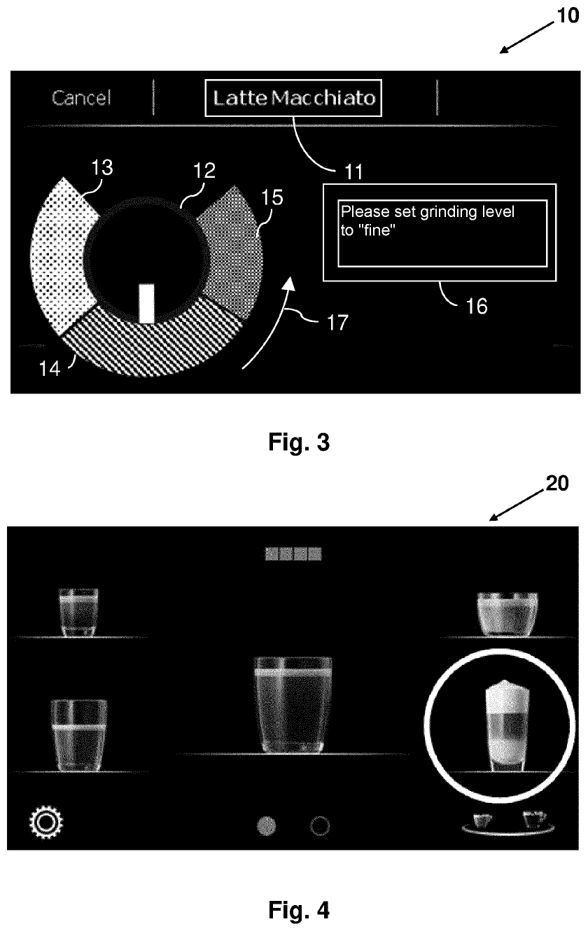

FIG. 3 shows a first user interface 10 of a grinding mill or a device comprising the grinding mill, for example a coffee machine. The first user interface 10 comprises a first information display 11 in which, or with which, a product selection is displayed. The displayed selected product may be predetermined or pre-selected or selectable by the user. The first user interface 10 further comprises a control element 12 for setting a grind level. A set grind level corresponds to the actual grind level. The first user interface 10 further comprises first, second and third grind level indicators 13, 14, 15. The control element 12 can be set to one of the grind level indicators 13, 14, 15 in order to select a specific grind level. The first grind level indicator 13 represents a first grind level or first grind level range, in the example shown a coarse grind level or coarse grind level range. The second grind level indicator 14 represents a second grind level or second grind level range, in the example shown a medium grind level or medium grind level range, which is finer than the first grind level or the first grind level range. The third grind level indicator 15 represents a third grind level or third grind level range, in the example shown a fine grind level or grind level range, which is finer than the second grind level or the second grind level range.

The first user interface 10 further comprises a second indication display 16. The second indication display 16 can be used to visually display information to the user. For example, information can be displayed to the user if a set actual grind level does not correspond to a target grind level or a target grind level range that corresponds to a selected product (and is displayed with the information display 11), or is predetermined, optimal and/or recommended for this product. In the example shown, the user is prompted to adjust the actual grind level, namely to the fine grind level, by the information displayed in the information display 16. In the example shown, the actual grind level is coarser than the target grind level. The actual grind level is set to the medium grind level, the target grind level corresponds to the fine grind level.

In addition or as an alternative, the user interface 10 can include a third information display 17. The third information display 17 can provide the user with visual information. The information displayed with the information display 17 indicates to the user a direction of adjustment of the actual grind level towards a finer grind level. In this way, the user is prompted to adjust the set actual grind level to a finer grind level, in particular to the fine grind level, just as with the information display 16.

Alternatively or additionally, information can be given to the user of the grinding mill by illuminating one or more of the grind level indicators 13, 14, 15. For example, the second grind level indicator 14 can be visually emphasized with respect to the first and third grind level indicators 13 and 15, i.e. illuminated more strongly, for example, when the actual grind level corresponds to the average grind level, as shown in the illustrated example. In this way, the information to the user of the grinding mill can include the information of the actual grind level.

In addition or alternatively, information can be issued by visually highlighting one of the grind level indicators 13, 14, 15, which is directed to the target grind level or the target grind level range. In the example shown, the user can be informed that the target grind level (range) is the fine grind level (range) by the third grind level indicator 15 lighting up or being visually highlighted. Similarly, an adjustment direction of the control element 12 can be indicated by visually highlighting one or more of the grind level indicators 13, 14, 15. For example, when the control element 12 is set to the coarse grind level, i.e. to the first grind level indicator 13, first the second grind level indicator 14 and then the third grind level indicator 15 can be visually highlighted, for example light up when the fine grind level corresponds to the target grind level. In this way, the information to the user of the grinding mill can include the output of the target grind level.

The preferably automatic output of the information, for example via the grind level displays 13, 14, 15 and/or the indication displays 16, 17, can take place, for example, in the method steps 150 of the methods 100 or 200 of FIGS. 1 and 2.

FIG. 4 shows a second user interface 20 for selecting a product, in the example shown a coffee product, by a user of the grinding mill via a user input, for example a touch input. The user input for selecting the product can take place, for example, in the method steps 120 of the methods 100 or 200 of FIGS. 1 and 2. The product selected via the second user interface 20 can be displayed in the first information display 11 of the user interface 10 shown in FIG. 3.

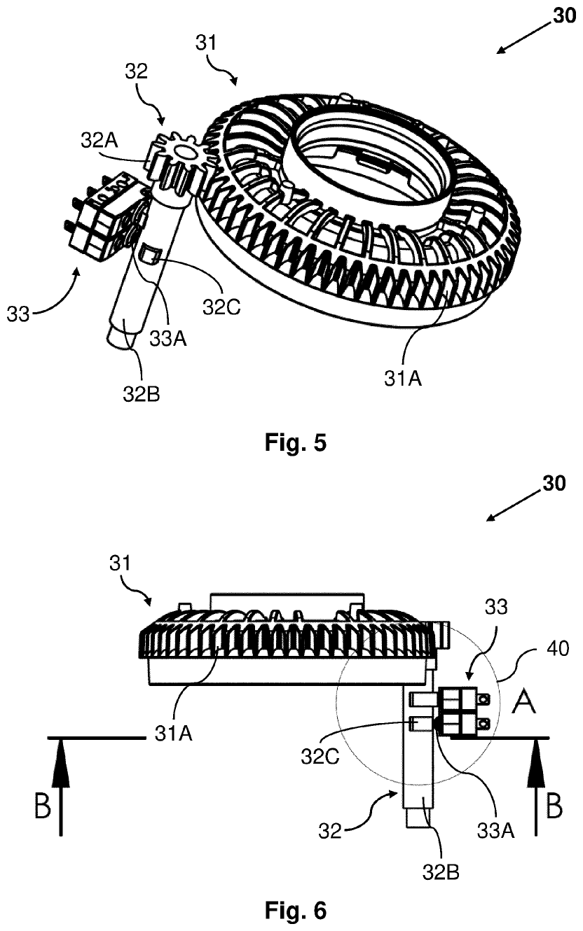

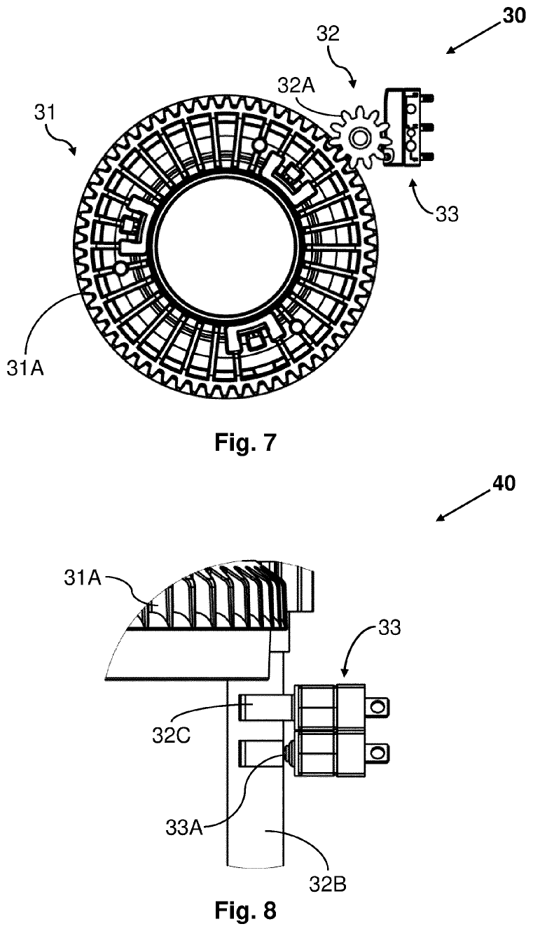

FIGS. 5 to 8 show a device 30 for adjusting and monitoring the grind level of a grinding mill. FIG. 5 shows a three-dimensional view of the device 30. FIG. 6 shows a side view of the device 30. FIG. 7 shows a top view of the device 30. FIG. 8 shows an enlarged section 40 of the side view in FIG. 6. Identical or similar features are provided with identical reference signs.

As shown in FIGS. 5 to 8, the device 30 comprises an adjustment element 31. The adjustment element 31 may comprise the control element 12 of the user interface 10 shown in FIG. 3 or be coupled thereto. By actuating the adjustment element 31, a grind level of the grinding mill can be adjusted, or the actual grind level of the grinding mill can be set.

The device 30 further comprises a transmission element 32. The transmission element 32 is designed to transmit an adjustment of the adjustment element 31, or the grinding mill, to a sensor 33 of the device 30. The transmission element 32 comprises first coupling means 32A, which can be coupled to second coupling means 31A of the adjustment element 31 in order to transmit an adjustment or a movement, in particular a rotation of the adjustment element 31 into a corresponding adjustment or movement, in particular rotation of the transmission element 32. In the example shown, the gear-shaped coupling means 32A engage in correspondingly shaped gear-shaped coupling means 31A.

The transmission element 32 further comprises a roller 32B and elevations or projections 32C, which are attached to the roller 32B or encompassed by it. The elevations 32C are arranged radially and/or axially spaced from each other on an outer circumference of the roller 32B.

The device 30 comprises a sensor 33. The sensor 33 comprises several micro-sensors 33A. Depending on the setting position of the transmission element 32, or the roller 32B, different micro-sensors 33A of the sensor 33 are actuated by the elevations 32C.

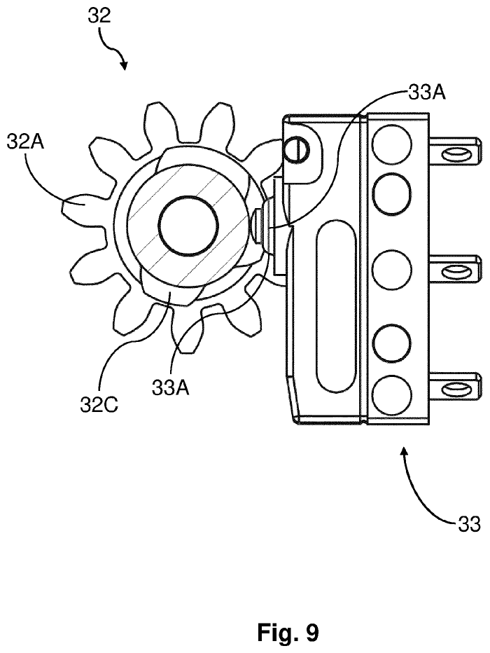

FIG. 9 shows a top view of the transmission element 32 and the sensor 33. Identical or similar features are marked with the same reference signs. As shown in FIG. 9, the elevations 33C can, on the one hand, be arranged radially and axially offset on the roller 32B. On the other hand, the plurality of elevations 32C may have different widths or extend along the outer circumference of the roller 32B over different lengths. In other words, the elevations 32C can encompass or cover a radial area of the roller 32B of different sizes.

By means of an appropriately selected arrangement and design of the elevations 32C, the sensor 33 can clearly determine a setting or an adjustment of the setting element 31, for example the actual grind level, by means of the micro-sensors 33A, in particular over a specific range of rotation, for example over a range of rotation greater than 360°.

1-19. (canceled)

20. Method for grinding material to be ground having at least one coffee grinding mill in a coffee machine, the method comprising:
determining an actual grind level of the grinding mill;
determining a target grind level of the grinding mill based on a coffee product selected by a user,
comprising: receiving a first user input; and determining the target grind level based on the received first user input, wherein the first user input is associated with the selection of a coffee product;
automatically comparing the actual grind level with the target grind level;
automatically outputting information to a user of the grinding mill based on the comparison of the actual grind level with the target grind level;
receiving a second user input; and
when the actual grind level matches the target grind level:
grinding the material to be ground with the actual grind level;
when the actual grind level does not match the target grind level:
grinding of the material to be ground with the actual grind level, or
adjusting the actual grind level to set the target grind level,
wherein the grinding of the material to be ground with the actual grind level or
adjusting the actual grind level is performed in response to the receiving the second user input.

21. Method according to claim 20, further comprising:
outputting information to the user of the grinding mill if the actual grind level does not match the target grind level, in particular wherein it is automatically output whether and/or by how much the actual grind level should be increased or reduced in order to achieve the target grind level.

22. Method according to claim 20, wherein the grinding of the material to be ground with the actual and/or the target grind level takes place in response to the expiry of one or more preferably predetermined first time intervals, in particular from the first user input, the second user input, the adjustment of the grind level, the adjustment of a control element and/or the output of the information to the user.

23. Method according to claim 20, wherein the adjustment of the actual grind level takes place in response to the expiry of one or more preferably predetermined second time intervals, in particular from the first user input, the second user input, the adjustment of the or a control element and/or the output of the information to the user.

24. Method according to claim 20, wherein the information to the user of the grinding mill comprises an indication of the actual and/or target grind level;
and/or
wherein the information to the user of the grinding mill comprises an indication of a desired setting of a control element of the grinding mill for adjusting the grind level.

25. Method according to claim 20, wherein the information to the user of the grinding mill comprises a specification for setting the target grind level and/or a specification for adjusting the control element of the grinding mill.

26. Method according to claim 20, wherein the determination of the actual grind level comprises the determination of an actual value or an actual value range for the set grind level;
wherein the determination of the target grind comprises the determination of a target value or a range of target values for the target grind; and
wherein the output of information to the user of the grinding mill comprises the output of information to the user of the grinding mill when the target value or target value range does not at least partially correspond to the actual value or actual value range.

27. Method according to claim 20, wherein the determination of the actual grind level comprises the determination of a position of a control element of the grinding mill and/or the determination of a position of an adjustable grinding mill element of the grinding mill, in particular the determination of a position of a first grinding mill element of the grinding mill relative to a second grinding mill element of the grinding mill.

28. Method according to claim 20, wherein the grinding mill comprises sensors and wherein the determination of the actual grind level, in particular the determination of the position of a control element of the grinding mill, in particular a control element of a preferably manually operable and/or mechanical adjustment device of the grind level, and/or the determination of the position of the grinding mill element of the grinding mill, is carried out on the basis of sensor data of the sensors.

29. Method according to claim 20, wherein the output of the information to the user of the grinding mill is carried out visually, preferably via a display and/or via the illumination of at least one region of the control element.

30. Method according to claim 20, wherein the method comprises the grinding of material to be ground with a plurality of grinding mills, wherein the output of the information to the user of the grinding mill based on the comparison of the respective actual grind level with the respective target grind level comprises the output of respective, in particular different, information.

31. Method according to claim 20, further comprising:
actuating a cleaning process to clean the grinding mill, in particular when the actual grind level does not match the target grind level and preferably in response to or during the automatic output of the indication.

32. Method according to claim 31, wherein the actuation of the cleaning process comprises adjusting the actual grind level to set a transitional grind level different from the target grind level, which is preferably coarser than the actual grind level and/or the target grind level.

33. Method according to claim 32, wherein the actuation of the cleaning operation comprises the actuation of the grinding mill in a reverse direction, preferably opposite to a grinding direction.

34. Coffee machine having a grinding mill and a processor, wherein the processor is configured to carry out the method according to one of the preceding claims, in particular wherein the coffee machine has a preferably manually operable and/or mechanical adjustment device of the grind level and/or an optically readable display device, preferably a display and/or a controlled illuminable region.
